(19) United States
(12) Patent Application Publication
(10) Pub. No.: US 2005/0038892 A1
(43) Pub. Date: Feb. 17, 2005

(54) Method for wireless communication and apparatus for conducting the same

(75) Inventors: Shuangying Huang, Sunnyvale, CA (US); Ivan C. Wong, San Jose, CA (US)

Correspondence Address: MARTINE & PENILLA, LLP, 710 LAKEWAY DRIVE, SUITE 170, SUNNYVALE, CA, 94085, US

(73) Assignee: Sun Microsystems, Inc., Santa Clara, CA (US)

(21) Appl. No.: 10/640,727

(22) Filed: Aug. 13, 2003

(51) Int. Cl. G06F 15/16

(52) U.S. Cl. 709/227

(57) ABSTRACT

Broadly speaking, a method and an apparatus are provided for implementing and performing wireless communication. More specifically, a Java based client application is operated on a wireless device having either a connected limited device configuration (CLDC) or a connected device configuration (CDC). A connection is established between the Java based client application and a server. Data is then transmitted through the connection between the Java based client application and the server.

### BACKGROUND OF THE INVENTION

1. Field of the Invention

The present invention relates generally to wireless communication. More specifically, the present invention relates to a communication interface between a wireless network and a wired network.

2. Description of the Related Art

Wireless communication devices generally implement a native operating system and one or more software applications defined to operate in conjunction with the specific native operating system and device. The software applications provide the functional interface between the wireless communication device and a network through which wireless communications traverse to reach their destinations. The software applications are often called native applications because they are defined to only operate on the specific native operating system and the associated device. The native applications are fixed during fabrication of the device and cannot be subsequently modified. Therefore, to modify a native application, it is necessary to replace the wireless device. Replacement of wireless devices to obtain improved functionality at the native application level can become expensive and burdensome for consumers.

Additionally, native applications are generally defined to comply with existing communication protocols. However, existing communication protocols are continually being modified or superceded. Therefore, native applications complying with existing communication protocols at the time of wireless device fabrication become quickly outdated as technology progresses. Hence, the wireless device that is dependent on the native application for functionality becomes quickly outdated.

In view of the foregoing, there is a need for a functional interface between the wireless device and the wireless communication network that does not rely on a native application.

### SUMMARY OF THE INVENTION

Broadly speaking, an invention is disclosed for a method and an apparatus for implementing and performing wireless communication. More specifically, the present invention provides a Java based Multimedia Messaging Service (MMS) client operable on a wireless device having Java support. The Java based MMS client is implemented to provide flexible and efficient wireless communication through an MMS environment (MMSE). The Java based MMS client can communicate directly with an internet network (i.e., without first communicating with a translation layer). Also, the Java based MMS client can be downloaded and modified independently from a fixed operating system of the wireless device.

In one embodiment, a method for performing wireless communication is disclosed. The method includes operating a Java based client application on a wireless device having a connected limited device configuration (CLDC). The method also includes establishing a connection between the Java based client application and a server. The method further includes transmitting data through the connection between the Java based client application and the server.

In another embodiment, another method for performing wireless communication is disclosed. This method includes operating a Java based client application on a wireless device having a connected device configuration (CDC). This method, like the previously described method, includes establishing a connection between the Java based client application and a server. Also, this method further includes transmitting data through the connection between the Java based client application and the server.

In another embodiment, a computer readable media containing program instructions for performing wireless communication is disclosed. The computer readable media includes program instructions for operating a Java based client application on a wireless device having either a CLDC or a CDC. Program instructions are also included for establishing a connection between the Java based client application and a server. The computer readable media includes further program instructions for transmitting data through the connection between the Java based client application and the server.

In another embodiment, a method for implementing a peer-to-peer wireless communication is disclosed. The method includes an operation for posting a message. Posting the message includes operating a first Java based client application on a first wireless device having either a CLDC or a CDC. The first Java based client application is directed to compose the message. A wireless connection between the first wireless device and a server is then initiated by the first Java based client application. The message is then transmitted from the first wireless device to the server. Transmittal of the message is directed by the first Java based client application. The method includes another operation for providing notification that the message is available on the server. The operation for providing notification includes operating a second Java based client application on a second wireless device having either a CLDC or a CDC. A wireless connection between the server and the second wireless device is initiated by the server. A first notification is then transmitted from the server to the second wireless device to inform the second wireless device that the message is available on the server. Transmittal of the first notification is directed by the server. The method further includes an operation for retrieving the message. Retrieving the message includes initiating a wireless connection between the second wireless device and the server, wherein the initiating is performed by the second Java based client application. The message is then retrieved from the server to the second wireless device. Retrieval of the message is directed by the second Java based client application. A wireless connection is also initiated between the server and the first wireless device, wherein the initiating is performed by the server. A second notification is transmitted from the server to the first wireless device to inform the first wireless device that the message has been retrieved. Transmittal of the second notification is directed by the server.

In another embodiment, a wireless device is disclosed. The wireless device includes a native operating system and a virtual machine defined to operate in conjunction with the native operating system. The virtual machine is embodied within either a CLDC or a CDC. The wireless device also includes a Java based client defined to operate in conjunction with the virtual machine. The Java based client is configured to enable wireless communication with a server using an internet protocol.

Other aspects of the invention will become more apparent from the following detailed description, taken in conjunction with the accompanying drawings, illustrating by way of example the present invention.

### BRIEF DESCRIPTION OF THE DRAWINGS

The invention, together with further advantages thereof, may best be understood by reference to the following description taken in conjunction with the accompanying drawings in which:

FIG. 1 is an illustration showing a Multimedia Messaging Service Environment (MMSE), in accordance with one embodiment of the present invention;

FIG. 2A is an illustration showing a software stack for implementing a Java based MMS client on a mobile device, in accordance with one embodiment of the present invention;

FIG. 2B is an illustration showing a software stack for implementing a Java based MMS client on a mobile device, in accordance with one embodiment of the present invention;

FIG. 3 is an illustration showing a data flowpath between two MMS clients within an MMSE;

FIG. 4 is an illustration showing a data flowpath between two Java based MMS clients within an MMSE, in accordance with one embodiment of the present invention; and

FIG. 5 shows a flowchart illustrating a method for communicating within an MMSE, in accordance with one embodiment of the present invention.

### DETAILED DESCRIPTION

Broadly speaking, an invention is disclosed for a method and an apparatus for implementing and performing wireless communication. More specifically, the present invention provides a Java based Multimedia Messaging Service (MMS) client operable on a wireless device having Java support. The Java based MMS client is implemented to provide flexible and efficient wireless communication through an MMS environment (MMSE). The Java based MMS client can communicate directly with an internet network (i.e., without first communicating with a translation layer). Also, the Java based MMS client can be downloaded and modified independently from a fixed operating system of the wireless device.

It should be appreciated that the present invention can be implemented in numerous ways, including as a process, an apparatus, a system, a device, or a method. Several exemplary embodiments of the invention will now be described in detail with reference to the accompanying drawings.

In the following description, numerous specific details are set forth in order to provide a thorough understanding of the present invention. It will be apparent, however, to one skilled in the art that the present invention may be practiced without some or all of these specific details. In other instances, well known process operations have not been described in detail in order not to unnecessarily obscure the present invention.

In general, wireless transmissions are performed using either a Short Messaging Service (SMS) or a MMS. The SMS operates based on a message-push paradigm and is limited to the throughput provided by a signal channel. As a consequence, each SMS transmission is limited to a maximum of 160 text characters. The MMS, however, uses both the signal channel and a data channel for transmitting data. Hence, the MMS is capable of handling larger and more complex amounts of data. For example, the MMS can accommodate standard multimedia formats such as GIF (image), JPEG (image), MPEG-4 (video), AMR (sound), MP3 (sound), and MIDI (sound), among others. The MMS can be used for peer-to-peer (e.g., wireless phone-to-wireless phone) communications and for communications to other email clients (e.g., accessible from a desktop computer system). The MMS is currently based on the use of a Wireless Application Protocol (WAP) for client/server communications.

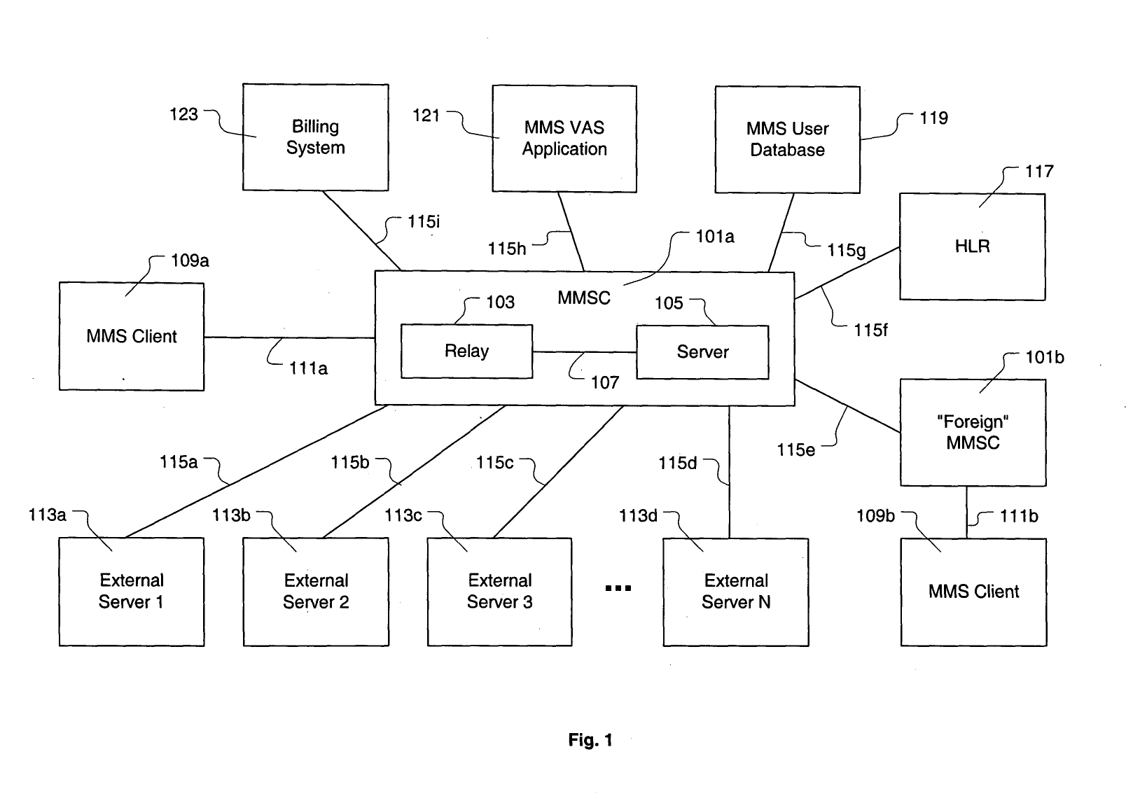

FIG. 1 is an illustration showing a Multimedia Messaging Service Environment (MMSE), in accordance with one embodiment of the present invention. The MMSE includes a Multimedia Messaging Service Center (MMSC) 101a. The MMSC 101a functions to store incoming messages, provide notifications to recipients and senders, provide reports, and perform other general message handling operations. As such, the MMSC 101a serves as a hub within the MMSE. The MMSC 101a contains a relay component 103 and a server component 105. The relay component 103 and the server component 105 communicate with each other through an internal interface 107. Also, the MMSC 101a resides and operates within an internet network.

The MMSE also includes an MMS client 109a. The MMS client 109a resides in a wireless network and communicates with the MMSC 101a through an interface 111a. Therefore, communication between the MMS client 109a and the MMSC 101a represents communication between the wireless network and the internet network. As previously mentioned, the WAP has been traditionally used for communication between the MMS client 109a and the MMSC 101a. The MMS client 109a is capable of composing messages, submitting messages, receiving messages, and presenting messages.

Also, within the MMSE, a number of external servers 113a-113d are in communication with the MMSC 101a through a number of interfaces 115a-115d, respectively. The number of external servers can vary depending on the specific configuration of the MMSE architecture. As such, FIG. 1 shows the external server 113d as being the N^{th} external server. Each external server 113a-113d can be configured to perform particular tasks. For example, external servers 113a-113d can be configured as either an email server, a fax server, or an SMS server, among others. It should be appreciated that an external server 113a-113d can be provided for performing many additional functions beyond those specifically exemplified. Each external server 113a-113d communicates with the MMSC 110a, through its respective interface 115a-115d, using a protocol that is appropriate for the particular task being performed by the external server 113a-113d. For example, if the external server 113a is an email server, communication through the interface 115a may be performed using Simple Mail Transfer Protocol (SMTP).

In one embodiment, the MMSE includes a home location registry (HLR) 117 in communication with the MMSC 101a through an interface 115f. The HLR 117 represents a database of client profiles (i.e., user profiles). The client profiles may include information such as a client address (e.g., cell phone number) and a client location (e.g., base station identifier), among others. In various embodiments, communication between the HLR 117 and the MMSC 101a may be performed using either Manufacturing Automation Protocol (MAP), Lightweight Directory Access Protocol (LDAP), or Enum/Domain Name System (DNS), among others.

Also, in one embodiment, the MMSE includes an MMS User Database 119 in communication with the MMSC 101a through an interface 115g. The MMS User Database 119 contains information regarding the various clients in communication with the MMSC 110a. For example, if the client is represented as a cell phone, the MMS User Database 119 may contain information regarding capabilities of the cell phone such as display size, available memory, and supported media formats, among others. In various embodiments, the MMSE may include more than one MMS User Database 119.

The MMSE can also include a billing system 123 in communication with the MMSC 101a through an interface 115i. In one embodiment, the billing system 123 can be represented as an independent computing system using an internet protocol (IP) to communicate with the MMSC 101a.

An MMS Value Added Service (VAS) Application 121 is also shown as part of the MMSE. The MMS VAS Application 121 is in communication with the MMSC 101a through an interface 115h. The MMS VAS Application 121 represents a computer implemented application for processing information received from the MMS client 109a and generating information to be transmitted to the MMS client 109a. For example, one MMS VAS Application 121 can be defined to generate selected stock quotes for the MMS client 109a at a particular time each day. In this example, the MMS VAS Application 121 will communicate with the MMSC 101a to transmit the stock quotes to the MMS client 109a. It should be appreciated that many MMS VAS Applications 121 can be in communication with the MMSC 101a to address a number of diverse MMS client 109a needs. In various embodiments, communication between the MMS VAS Application 121 and the MMSC 101a may be performed using either Simple Object Access Protocol (SOAP) or Hypertext Transfer Protocol (HTTP), among others.

In general, communication through the interfaces 115a-115i, as shown in FIG. 1, is performed using an IP. However, there are a number of different IPs available for use. The IP used for communication through a particular interface 115a-115i is dependent on the type of data being transferred.

Further with respect to FIG. 1, the MMSC 101a can be in communication with a “Foreign” MMSC 101b through an interface 115e. The “Foreign” MMSC 101b can be configured in a manner similar to the MMSC 101a, but within a different MMSE. In one embodiment, the “Foreign” MMSC 101b is in communication with an MMS client 109b through an interface 111b. In this embodiment, the MMS client 109b and the interface 111b are analogous to the MMS client 109a and the interface 111a, respectively. In one example, the MMSC 101a can be represented as a first telecommunication entity (e.g., Sprint) and the “Foreign” MMSC 101b can be represented as a second telecommunication entity (e.g., AT&T). For the MMS client 109a (e.g., Sprint customer) to communicate with the MMS client 109b (e.g., AT&T customer), the MMSC 111a will communicate with the “Foreign” MMSC 101b through the interface 115e.

Traditionally, the MMS client 109a/109b is defined as a native MMS client configured to operate specifically on a native operating system of a host device. The native MMS client is fixed at the time of manufacture of the host device and is generally not operable outside of the native operating system of the host device. Also, modifications to the native MMS client cannot be implemented without replacement of the host device.

As an alternative to the native MMS client, the present invention provides for a Java based MMS client. The Java based MMS client offers flexibility and communication interface improvements that cannot be realized with the native MMS client. For example, the Java based MMS client allows any mobile device that supports Java to be converted into an MMS client. Thus, eliminating a need for a consumer to replace their existing mobile device (having Java support) to obtain MMS client capability. Also, the Java based MMS client can be updated through downloads without having to replace the host device, as required with the native MMS client. Additionally, the Java based MMS client can be customized to suit particular preferences. Conversely, the native MMS client cannot be modified or customized subsequent to fabrication of the host device.

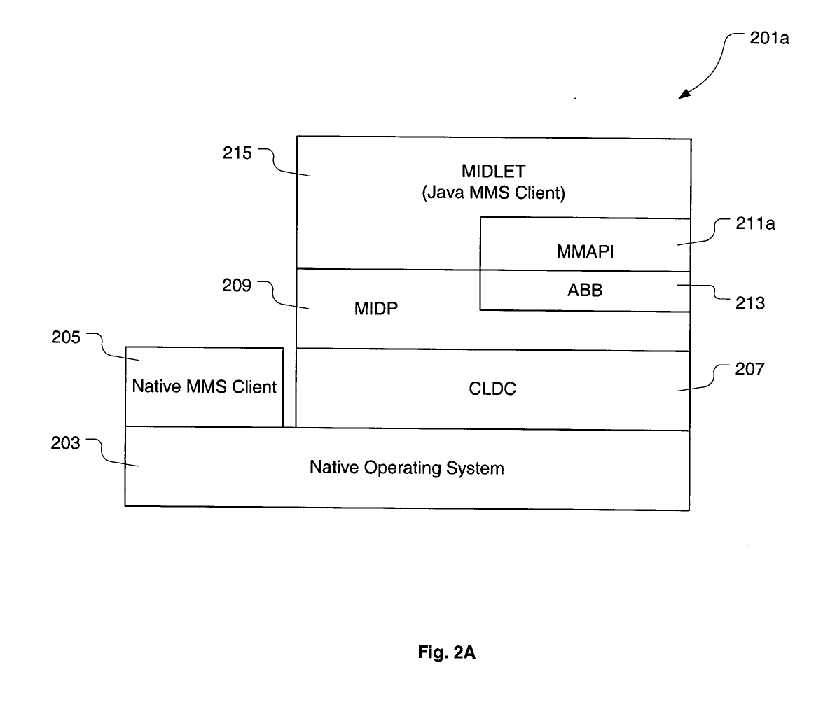

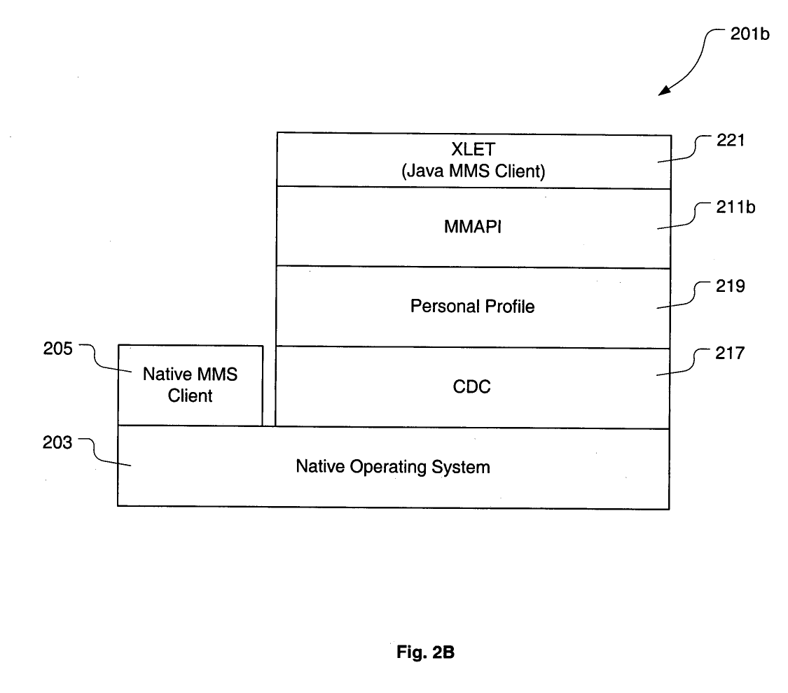

FIG. 2A is an illustration showing a Java 2 Platform Micro Edition (J2ME) software stack 201a for implementing a Java based MMS client on a mobile device, in accordance with one embodiment of the present invention. At a base of the software stack 201a, an operating system 203 is defined. In one embodiment, a native MMS client 205 can be provided. The native MMS client 205 is generally configured to operate specifically in the operating system 203. Other embodiments of the present invention may not include the native MMS client 205. The software stack 201a also includes a Connected Limited Device Configuration (CLDC) 207 built upon the native operating system 203. The CLDC 207 is composed of a light-weight Java virtual machine and a minimal set of Java class libraries. The CLDC 207 serves to provide a base functionality for a particular range of mobile devices that share similar characteristics, such as intermittent network connections, slow processors, and limited memory (e.g., wireless phones). A Mobile Information Device Profile (MIDP) 209 including a set of higher-level Java Application Programming Interfaces (APIs) is built upon the CLDC 207. The MIDP 209 further defines a complete J2ME runtime environment required by mobile applications, including items such as application life cycle model, user interface, networking, storage, application management, gaming, and audio. The MIDP 209 includes an audio component represented as an Audio Building Block (ABB) 213. The ABB 213 is an audio subset of a Mobile Media Application Programming Interface (MMAPI) 211a. The MMAPI 211a is an optional package to further extend the capabilities and services provided by MDP 209, specifically to address the needs of playing, capturing, and recording media content. A MIDLET 215 represents a mobile application written in MIDP 209 and MMAPI 211a, running on the J2ME platform. Thus, in one example, the MIDLET 215 is a J2ME application to operate on a wireless phone. In one embodiment, the Java based MMS client is implemented as the MIDLET 215.

FIG. 2B is an illustration showing a J2ME software stack 201b for implementing a Java based NMS client on a high-end mobile device, in accordance with one embodiment of the present invention. The software stack 201b of FIG. 2B includes the operating system 203 and the native MMS client 205 as previously described with respect to FIG. 2A. Again, the native MMS client 205 is generally configured to operate specifically in the operating system 203, and is not required with the present invention. The software stack 201b further includes a Connected Device Configuration (CDC) 217 built upon the operating system 203. The CDC 217 is similar to the CLDC 207 of FIG. 2A; however, the CDC 217 includes a full-featured Java virtual machine and a much larger subset of Java 2 Platform Standard Edition (J2SE) class libraries than CLDC 207. The CDC 217 is designed primarily for high-end devices that have more memory, faster processors, and greater network bandwidth (e.g., television set-top boxes and high-end PDAs). A personal profile 219 is built upon the CDC 217. The personal profile 219, similar to the MDP 209, further defines a runtime environment for more complicated/elaborate J2ME applications running on CDC 217. The personal profile 219 includes networking support and a complete set of Java Abstract Window Toolkit (AWT) libraries for advanced graphical user interface support. The personal profile 219 also offers web fidelity functionality. A MMAPI 211b, similar to MMAPI 211a in FIG. 2A, lays on top of the personal profile 219 to provide additional multimedia functionality such as playback, capturing, and recording. An XLET 221, as a mobile application, can be programmed using MMAPI 211b, personal profile 219, and CDC 217 to operate on the Java virtual machine residing within the CDC 217. In one embodiment, the Java based MMS client is implemented as the XLET 221.

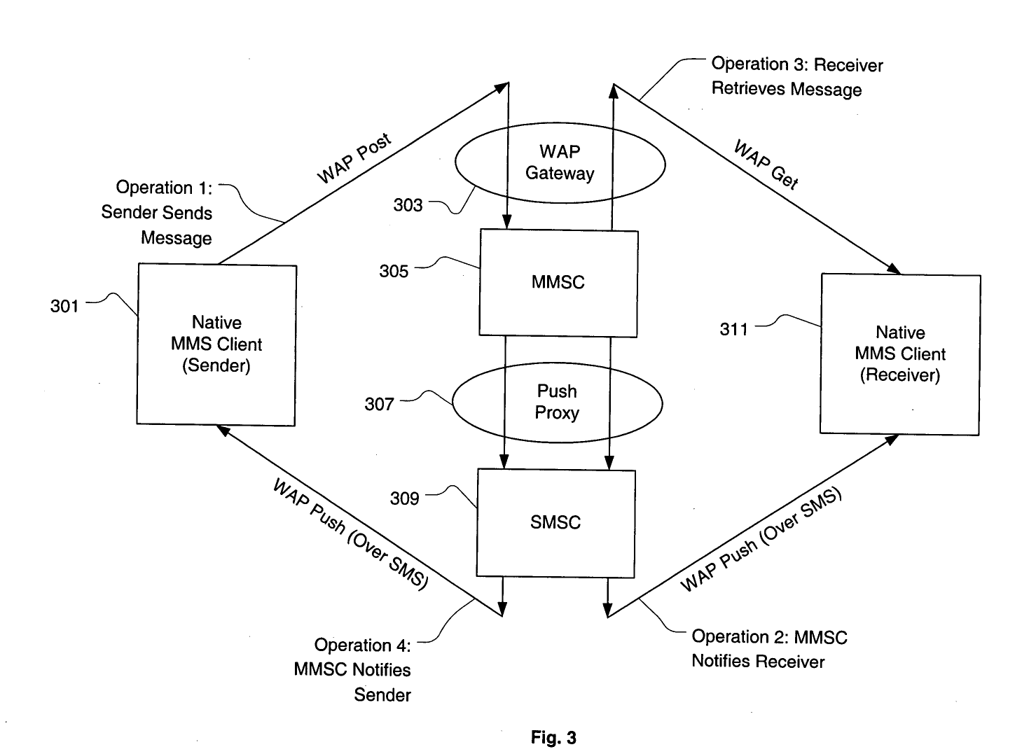

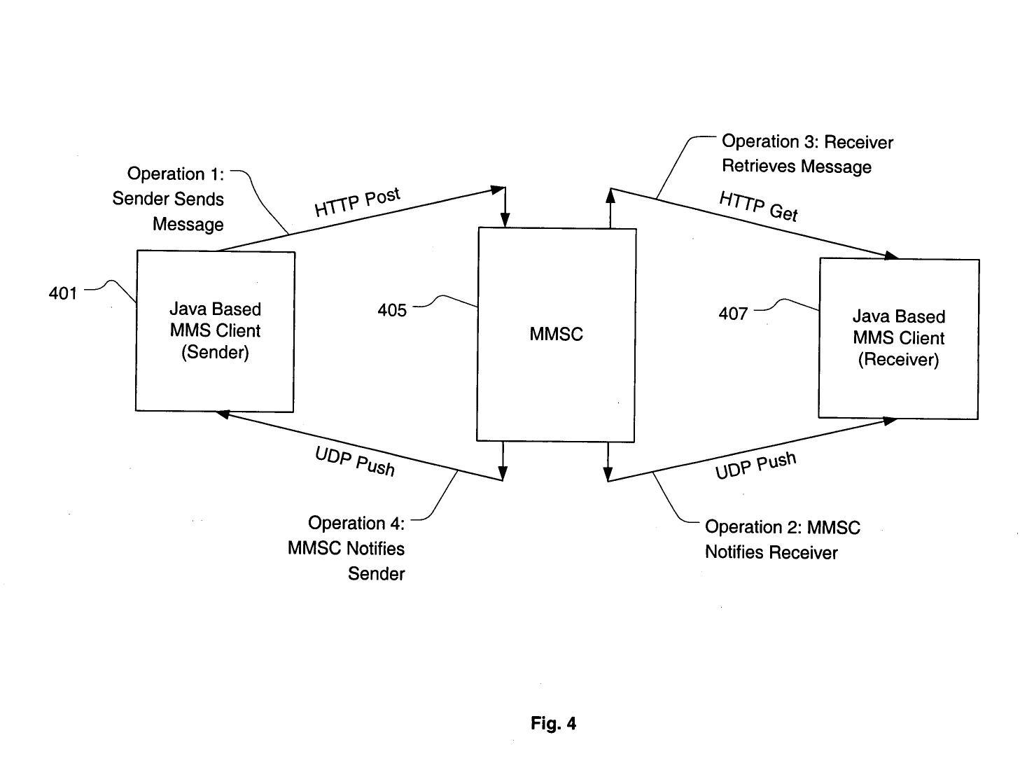

FIG. 3 is an illustration showing a data flowpath between two MMS clients within an NMSE. Neither of the two MMS clients depicted in FIG. 3 represent a Java based MMS client as provided by the present invention. As such, FIG. 3 represents the MMSE prior to realization of the benefits afforded by the present invention. Nevertheless, discussion of the MMSE of FIG. 3 provides a useful foundation for a subsequent discussion, with respect to FIG. 4, regarding implementation of the Java based MMS client, in accordance with the present invention.

With respect to FIG. 3, the data flowpath begins with a native MMS client 301 acting as a sender. The native MMS client 301 is configured to operate using WAP and only in conjunction with a native operating system. In an Operation 1, the native MMS client 301 sends a message to an MMSC 305. The message is sent in binary format using a WAP Post operation through a WAP Gateway 303. The WAP Gateway 303 represents software that serves to decode and encode requests and responses between a smart phone microbrowser and the internet. The WAP Gateway 303 will decode the WAP Post sent by the native MMS client 301 and generate a corresponding HTTP request to be sent to the MMSC 305.

Upon receipt of the message, the MMSC 305 performs an Operation 2 to inform another native MMS client 311, acting as a receiver, that the message is available for retrieval (i.e., download). In the Operation 2, the MMSC 305 uses a push proxy 307 and a simple messaging service center (SMSC) 309 to inform the native MMS client 311. The informing of the native NMS client 311 is performed using a WAP Push over the SMS (using the signal channel).

Once informed of the message availability, the native MMS client 311 (i.e., receiver) initiates an Operation 3 to retrieve the message from the MMSC 305. Retrieval of the message from the MMSC 305 is performed using a WAP Get operation through the WAP Gateway 303. The WAP Gateway 303 encodes the message for transmission to the native MMS client 311. Once the message is retrieved, the native MMS client 311 will decode and present the message.

Also, upon retrieval of the message by the native MMS client 311 (receiver), an Operation 4 is performed to inform the native MMS client 301 (sender) that the message has been delivered. In the Operation 4, the MMSC 305 uses the push proxy 307 and the SMSC 309 to send a WAP Push over the SMS to inform the native MMS client 301 that the message has been delivered.

FIG. 4 is an illustration showing a data flowpath between two Java based MMS clients within an MMSE, in accordance with one embodiment of the present invention. The data flowpath begins with a Java based MMS client 401 acting as a sender. The Java based MMS client 401 is configured to operate in conjunction with a virtual machine, as previously discussed with respect to FIGS. 2A and 2B. In one embodiment, the Java based MMS client 401 is a pure Java implementation. The Java based MMS client 401 can support message composition, message submission, message receipt, and message presentation. In one embodiment, the Java based MMS client 401 supports PNG image, ringtone, wave audio, and live audio recording. In an Operation 1, the Java based MMS client 401 sends a message to a MMSC 405. The message is sent using a HTTP Post operation. The Java based MMS client 401 allows HTTP to be used instead of WAP for communicating with the MMSC 405. Use of Java based MMS client 401 and HTTP instead of the native MMS client 301 and WAP provides for simplified implementation of the MMSE. For example, with the Java based MMS client 401 using HTTP, the WAP Gateway 303 is not required to decode and encode communications between the wireless network and the internet network. HTTP is also more flexible and efficient than WAP. For example, with HTTP a direct communication link can be established between the MMS client and an external server within the MMSE.

Upon receipt of the message, the MMSC 405 performs an Operation 2 to inform another Java based MMS client 407, acting as a receiver, that the message is available for retrieval. In the Operation 2, the MMSC 405 uses a User Datagram Protocol (UDP) Push operation to inform the Java based MMS client 407. The UDP Push operation sends a datagram (i.e., data packet) in a one-way transmission to the Java based MMS client 407 without requiring an acknowledgment (i.e., handshake) by the Java based MMS client 407. The datagram contains source and destination addresses and data. The Java based MMS client 407 allows the UDP Push to be used instead of the WAP Push over the SMS. Use of the Java based MMS client 407 and the UDP Push instead of the native MMS client 301 and the WAP Push provides for simplified implementation of the MMSE. For example, with the Java based MMS client 407 capable of receiving the UDP Push, the push proxy 307 and SMSC 309 of FIG. 3 are not required.

Once informed of the message availability, the Java based MMS client 407 (i.e., receiver) initiates an Operation 3 to retrieve the message from the MMSC 405. The Java based MMS client 407 can be defined to have capabilities equivalent to those previously described with respect to the Java based MMS client 401. Since the Java based MMS client 407 is capable of communicating with the MMSC 405 using an internet protocol, the retrieval of the message from the MMSC 405 is performed using a HTTP Get operation. Again, use of the Java based MMS client 407 eliminates the need for the WAP Gateway 303. Once the message is retrieved, the Java based MMS client 407 will present the message.

Also, upon retrieval of the message by the Java based MMS client 407 (receiver), an Operation 4 is performed to inform the Java based MMS client 401 (sender) that the message has been delivered. In the Operation 4, the MMSC 305 uses a UDP Push operation to inform the Java based MMS client 401 that the message has been delivered. Again, use of the Java based MMS client 401 and the UDP Push operation avoids the need to incorporate the push proxy 307 and SMSC 309 of FIG. 3. In one embodiment, the MMSC 405 is implemented using Java. However, it should be appreciated that the MMSC 405 can be implemented using many different software/hardware platforms.

In one embodiment, the Java based MMS client can be implemented as an interoperable Java based desktop MMS client running on MMAPI and personal Java stack. With the interoperable Java based desktop MMS client, messages (e.g., email) can be sent from a mobile device (e.g., wireless phone) to a desktop, vice versa, using a data flowpath similar to that depicted in FIG. 4.

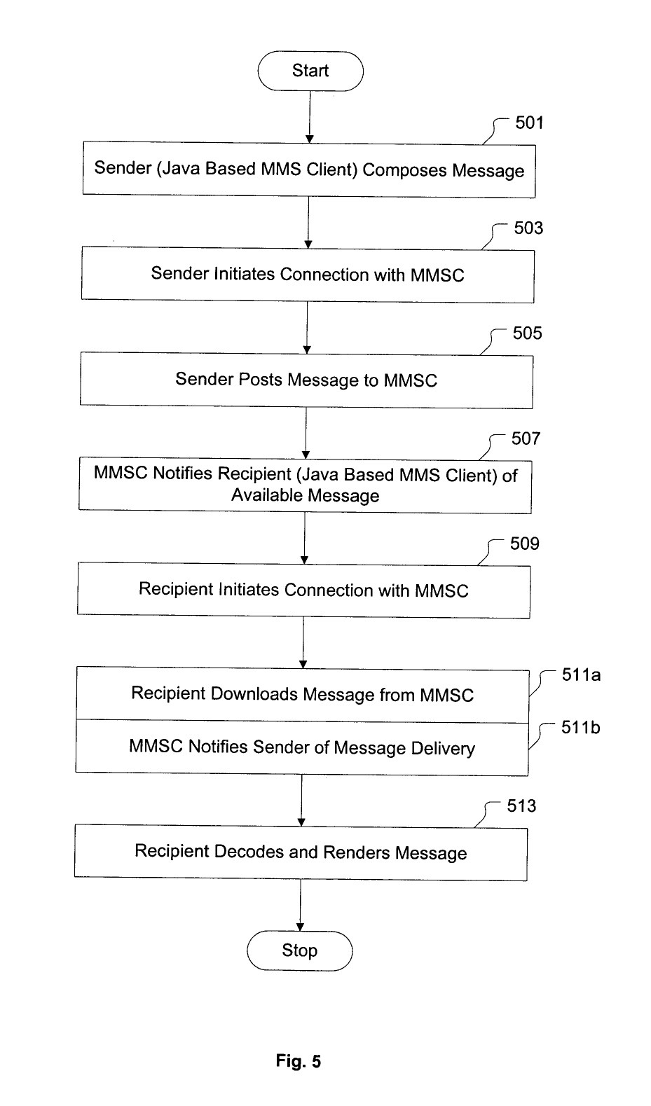

FIG. 5 shows a flowchart illustrating a method for communicating within an MMSE, in accordance with one embodiment of the present invention. In an operation 501, a Java based MMS client acting as a sender composes a message. In one embodiment, the message is composed by providing input to a graphical user interface (GUI). The input provided to the GUI is used to generate a Synchronized Multimedia Integration Language (SMIL) file and a media file. The SMIL file contains presentation information and the media file contains data for text, graphics, and audio. The SMIL file and media file are used to generate a Multipurpose Internet Mail Extensions (MIME) format version of the composed message. In an operation 503, the sender initiates a connection with an MMSC. In one embodiment, the connection is established using HTTP. In an operation 505, the sender posts the composed message (i.e., MIME file) to the MMSC using the established connection. In one embodiment, a header is attached to the composed message for indicating an identifier of the intended message recipient, along with other properties of the message. In the embodiment where the connection is established using HTTP, the composed message is posted in text format. However, in other embodiments, the message handling can be performed using binary format.

In an operation 507, the MMSC notifies another Java based MMS client acting as the intended recipient that a message is available for retrieval. In one embodiment, the MMSC will access the MMS User Database to determine whether or not the recipient is capable of receiving the message (e.g., capable of rendering embedded graphics or other content). Also, as part of operation 507, the MMSC can access the HLR to determine necessary routing information for establishing connection with the intended recipient. In one embodiment, the operation 507 is performed through the transmission of a datagram using a UDP Push operation.

In an operation 509, the recipient initiates a connection with the MMSC. In one embodiment, the connection is established using HTTP. In an operation 511a, the recipient downloads the message (i.e., MIME file) from the MMSC. In one embodiment, the download of operation 511a is performed using an HTTP Get command. When the recipient downloads the message in operation 511a, an operation 511b is also performed for notifying the sender that the message has been delivered to the recipient. In one embodiment, operation 511b is performed upon successful completion of the message download in operation 511a. Furthermore, in one embodiment, the operation 511b is performed through the transmission of a datagram using a UDP Push operation. In an operation 513, the message is decoded and rendered by the recipient. In the embodiment where the message is in the MIME format, the recipient will instantiate a SMIL player to render the message.

With respect to the native MMS client, the Java based MMS client of the present invention provides for more flexible and efficient wireless communication through the MMSE. Since the Java based MMS client can communicate directly with the internet network of the MMSE (e.g., using HTTP), the Java based MMS client can communicate directly with one or more MMS VAS Applications operating within the MMSE. More specifically, the Java based MMS client is not necessarily required to communicate through the MMSC in order to communicate with the MMS VAS Application. In comparison, the native MMS client is required to communicate through a translation layer (i.e., WAP Gateway) with a dedicated server (i.e., MMSC) within the MMSE. Thus, the native MMS client is required to communicate through the MMSC in order to communicate with the MMS VAS Application. In addition, due to its programmatic and downloadable nature, the Java based MMS client can be programmed to be a MMS message driven application installed on wireless devices to fulfill a specific MMS VAS service.

Since the Java based MMS client can be embodied as a downloadable software application, any MIDP-enabled wireless phone that supports Java can be converted into a Java based MMS client. Thus, a consumer can download the Java based MMS client software instead of upgrading their MIDP-enabled wireless phone to obtain MMS functionality.

Also, the Java based MMS client can be personalized and customized to suit a consumer's preferences. For example, the Java based MMS client can be customized to render a message in a certain font, size, or color. In another example, the Java based MMS client can be customized to render audio only (no video) to save memory and power. In contrast to the native MMS client, the flexibility of the Java based MMS client allows a consumer to obtain their desired preferences without incurring the expense of a new wireless phone.

With the above embodiments in mind, it should be understood that the invention may employ various computer-implemented operations involving data stored in computer systems. These operations are those requiring physical manipulation of physical quantities. Usually, though not necessarily, these quantities take the form of electrical or magnetic signals capable of being stored, transferred, combined, compared, and otherwise manipulated. Further, the manipulations performed are often referred to in terms, such as producing, identifying, determining, or comparing.

Any of the operations described herein that form part of the invention are useful machine operations. The invention also relates to a device or an apparatus for performing these operations. The apparatus may be specially constructed for the required purposes, or it may be a general-purpose computer selectively activated or configured by a computer program stored in the computer. In particular, various general-purpose machines may be used with computer programs written in accordance with the teachings herein, or it may be more convenient to construct a more specialized apparatus to perform the required operations.

The invention can also be embodied as computer readable code on a computer readable medium. The computer readable medium is any data storage device that can store data which can be thereafter be read by a computer system. Examples of the computer readable medium include hard drives, network attached storage (NAS), read-only memory, random-access memory, CD-ROMs, CD-Rs, CD-RWs, magnetic tapes, and other optical and non-optical data storage devices. The computer readable medium can also be distributed over a network coupled computer systems so that the computer readable code is stored and executed in a distributed fashion.

While this invention has been described in terms of several embodiments, it will be appreciated that those skilled in the art upon reading the preceding specifications and studying the drawings will realize various alterations, additions, permutations and equivalents thereof. It is therefore intended that the present invention includes all such alterations, additions, permutations, and equivalents as fall within the true spirit and scope of the invention.

1. A method for performing wireless communication, comprising:
operating a Java based client application on a wireless device having a connected limited device configuration (CLDC);
establishing a connection between the Java based client application and a server; and
transmitting data through the connection.

2. A method for performing wireless communication as recited in claim 1, wherein each of the operating, the establishing, and the transmitting is conducted through a software stack, the software stack being operable with a native operating system.

3. A method for performing wireless communication as recited in claim 2, wherein the software stack includes:
the CLDC being operable with the native operating system;
a mobile information device profile (MIDP) being operable with the CLDC, the MIDP including an audio building block (ABB);
a mobile media application programming interface (MMAPI) being operable with the MIDP; and
a MIDLET being operable with both the MIDP and the MMAPI, the MIDLET representing the Java based client application.

4. A method for performing wireless communication as recited in claim 1, wherein establishing the connection between the Java based client application and the server is initiated by the Java based client application.

5. A method for performing wireless communication as recited in claim 4, wherein transmitting data through the connection is performed to transmit the data from the Java based client application to the server.

6. A method for performing wireless communication as recited in claim 5, wherein transmitting data through the connection is performed using an HTTP Post operation.

7. A method for performing wireless communication as recited in claim 4, wherein transmitting data through the connection is performed to transmit the data from the server to the Java based client application.

8. A method for performing wireless communication as recited in claim 7, wherein transmitting data through the connection is performed using an HTTP Get operation.

9. A method for performing wireless communication as recited in claim 1, wherein establishing the connection between the Java based client application and the server is initiated by the server.

10. A method for performing wireless communication as recited in claim 9, wherein transmitting data through the connection is performed to transmit the data from the server to the Java based client application.

11. A method for performing wireless communication as recited in claim 10, wherein transmitting data through the connection is performed using a UDP Push operation.

12. A method for performing wireless communication as recited in claim 1, wherein the data represents a multimedia message.

13. A method for performing wireless communication as recited in claim 1, wherein the data represents a notification that a message is available for retrieval from the server.

14. A method for performing wireless communication as recited in claim 1, wherein the data represents a notification that a message has been retrieved from the server.

15. A method for performing wireless communication as recited in claim 1, wherein the server represents a component within a multimedia messaging service center.

16. A method for performing wireless communication as recited in claim 1, wherein the server represents an external server within a multimedia messaging service environment.

17. A method for performing wireless communication, comprising:
operating a Java based client application on a wireless device having a connected device configuration (CDC);
establishing a connection between the Java based client application and a server; and
transmitting data through the connection.

18. A method for performing wireless communication as recited in claim 17, wherein each of the operating, the establishing, and the transmitting is conducted through a software stack, the software stack being operable with a native operating system.

19. A method for performing wireless communication as recited in claim 18, wherein the software stack includes:
the CDC being operable with the native operating system;
a personal profile being operable with the CDC;
a mobile media application programming interface (MMAPI) being operable with the personal profile; and
an XLET being operable with the MMAPI, the XLET representing the Java based client application.

20. A method for performing wireless communication as recited in claim 17, wherein establishing the connection between the Java based client application and the server is initiated by one of the Java based client application and the server.

21. A method for performing wireless communication as recited in claim 17, wherein transmitting data through the connection is performed using one of an HTTP Post operation, and HTTP Get operation, and a UDP Push operation.

22. A method for performing wireless communication as recited in claim 17, wherein the data represents one of a multimedia message and a notification.

23. A method for performing wireless communication as recited in claim 22, wherein the notification represents one of a notification indicating that a message is available for retrieval from the server and a notification indicating that a message has been retrieved from the server.

24. A computer readable media containing program instructions for performing wireless communication, comprising:
program instructions for operating a Java based client application on a wireless device, the wireless device having one of a connected limited device configuration (CLDC) and a connected device configuration (CDC);
program instructions for establishing a connection between the Java based client application and a server; and
program instructions for transmitting data through the connection.

25. A computer readable media as recited in claim 24, wherein the program instructions for establishing the connection between the Java based client application and the server includes program instructions for enabling the Java based client application to initiate establishment of the connection.

26. A computer readable media as recited in claim 25, wherein the program instructions for transmitting data through the connection include program instructions for transmitting data from the Java based client application to the server using an internet protocol.

27. A computer readable media as recited in claim 25, wherein the program instructions for transmitting data through the connection include program instructions for transmitting data from the server to the Java based client application using an internet protocol.

28. A computer readable media as recited in claim 24, wherein the program instructions for establishing the connection between the Java based client application and a server includes program instructions for enabling the server to initiate establishment of the connection.

29. A computer readable media as recited in claim 28, wherein the program instructions for transmitting data through the connection include program instructions for transmitting data from the server to the Java based client application using an internet protocol.

30. A computer readable media as recited in claim 24, wherein the data represents one of a multimedia message and a notification.

31. A computer readable media as recited in claim 30, wherein the notification represents one of a notification indicating that a message is available for retrieval from the server and a notification indicating that a message has been retrieved from the server.

32. A computer readable media as recited in claim 24, wherein the server represents a component within a multimedia messaging service environment.

33. A method for implementing a peer-to-peer wireless communication, comprising:
posting a message, the posting including,
operating a first Java based client application on a first wireless device having one of a connected limited device configuration (CLDC) and a connected device configuration (CDC);
directing the first Java based client application to compose the message;
initiating a wireless connection between the first wireless device and a server, the initiating being performed by the first Java based client application; and
transmitting the message from the first wireless device to the server, the transmitting being directed by the first Java based client application;
providing notification of message availability, the providing including,
operating a second Java based client application on a second wireless device having one of a CLDC and a CDC;
initiating a wireless connection between the server and the second wireless device, the initiating being performed by the server; and
transmitting a first notification from the server to the second wireless device, the transmitting being directed by the server, the first notification informing the second wireless device of message availability; and
retrieving the message, the retrieving including,
initiating a wireless connection between the second wireless device and the server, the initiating being performed by the second Java based client application;
retrieving the message from the server to the second wireless device, the retrieving being directed by the second Java based client application;
initiating a wireless connection between the server and the first wireless device, the initiating being performed by the server; and
transmitting a second notification from the server to the first wireless device, the transmitting being directed by the server, the second notification informing the first wireless device of message retrieval.

34. A wireless device, comprising:
a native operating system;
a virtual machine defined to operate in conjunction with the native operating system, the virtual machine being embodied within one of a connected limited device configuration (CLDC) and a connected device configuration (CDC); and
a Java based client defined to operate in conjunction with the virtual machine, the Java based client being configured to enable wireless communication with a server using an internet protocol.

35. A wireless device as recited in claim 34, wherein the server is a component within a multimedia messaging service environment.

36. A wireless device as recited in claim 34, wherein the Java based client is configured to compose, transmit, receive, and render a multimedia message.

37. A wireless device as recited in claim 34, wherein the Java based client includes a graphical user interface to enable two-way communication with a user of the wireless device.

38. A wireless device as recited in claim 34, wherein the wireless device is a wireless phone.
